(19) United States
(12) Patent Application Publication
(10) Pub. No.: US 2026/0311007 A1
(43) Pub. Date: Oct. 8, 2026

(54) SYSTEM AND METHOD FOR ACCELERATING OPERATIONS OF AN AI AGENT ON A DIGITAL INTERFACE

(71) Applicant: Evinced, Inc., Los Altos Hills, CA (US)

(72) Inventors: Yossi SYNETT, Hod Hasharon (IL); Gal MOAV, Tel Aviv (IL); Navin R. THADANI, Los Altos Hills, CA (US); Evyatar Yaakov OR, Rosh Haayin (IL); Tair HAKMAN, Katzrin (IL); Kfir Yehuda ORGIL, Zofit (IL); Ben BRACHA, Tel Aviv (IL)

(73) Assignee: Evinced, Inc., Los Altos Hills, CA (US)

(21) Appl. No.: 19/436,863

(22) Filed: Dec. 30, 2025

Related U.S. Application Data
(60) Provisional application No. 63/784,515, filed on Apr. 7, 2025.

(51) Int. Cl. G06N 5/043

(52) U.S. Cl. CPC G06N 5/043; G06N 5/022; G06N 5/02; G06N 20/00

(57) ABSTRACT

The method and system for accelerating operations of an AI agent is presented. The method includes receiving, by a first AI agent, a task to be performed on at least one digital interface based on a natural language request from a client device; extracting, by the first AI agent, at least one learned skill to be used by the first AI agent for completing the task based on accessibility semantics of at least one component of the at least one digital interface, wherein learned skills are capabilities of the first AI agent to interact with the at least one component; and completing the task, by the first AI agent, using the at least one learned skill.

### CROSS-REFERENCE TO RELATED APPLICATIONS

This application claims the benefit of US Provisional Application No. 63/784,515 filed on Apr. 7, 2025, the contents of which are hereby incorporated by reference.

### BACKGROUND

AI agents are autonomous systems designed to perceive, interpret, and act in environments to achieve specific goals or tasks. These agents use artificial intelligence (AI) techniques, such as machine learning (ML), natural language processing (NLP), Large Language Models (LLMs), and computer vision, to make decisions and perform actions based on inputs from the environment. AI agents that operate on digital interfaces function by interacting with elements of the digital interfaces, but they are constrained by several challenges.

AI agents that operate on digital interfaces ultimately interact with computing systems through low-level input actions such as simulated key presses, pointer movements, and click events. While such micro-actions are sufficient to express any logical interaction with a digital interface, existing AI agents are required to explicitly reason about, select, and validate each individual micro-action in order to accomplish even higher-level tasks. As a result, although AI agents are capable of performing complex actions on digital interfaces, they must do so by repeatedly invoking an AI model to determine each successive micro-action, rather than by operating on higher-level, semantically meaningful abstractions of interface functionality. Further, AI agents are typically not presented with the functional semantics of a digital interface. Instead, agents are provided with rendered screenshots of the interface and textual metadata derived from underlying interface structures, such as document object model (DOM) elements. From this information, the agent must infer the functionality, purpose, and expected behavior of interface components.

One significant issue is that these agents often are not reliable when it comes to dealing with the unpredictable nature of digital interfaces. Unreliable behavior of AI agents on digital interfaces often arises not from dynamic or changing layouts themselves, but from interface components that lack correct, complete, or consistent semantic definitions. When components do not conform to expected semantic patterns, have missing or incorrect accessibility attributes, or behave in ways that are inconsistent with their declared semantics, the components respond unpredictably to agent interactions. This unpredictability makes it difficult for AI agents to reliably plan and execute interactions, even when the visual layout of the interface is otherwise stable.

The operation of these agents is also costly in terms of time, computational resources, and money. Each micro-step of the agent's task, such as clicking a button or entering text, requires a call to an AI model, which consumes processing power. After the AI model decides on an action, a screenshot of the digital interface is typically provided to the model, which then generates the next step. The process is repeated with each action and screenshot, consuming significant resources for every interaction, leading to inefficient operations.

Another challenge is that current LLM-based agents do not meaningfully learn from prior interactions with digital interfaces. A primary reason for this limitation is that such agents cannot persistently identify interactive and structural elements across repeated encounters when those elements lack stable, machine-readable accessibility semantics. Without persistent identifiers, agents have no reliable anchors on which to base learning or generalization across tasks. In the absence of accessibility semantics, agents must rely on fragile identifiers, such as class names, arbitrary attributes, or positional relationships within the interface structure, to locate and interact with components. These identifiers may change between sessions, differ across users, or vary as a result of interface updates. For example, a text input field intended to collect a phone number cannot be reliably identified across repeated visits if it lacks a semantic role and associated label. If multiple unlabeled text fields are present, the agent is unable to disambiguate their intended purposes, forcing the agent to resort to trial-and-error strategies.

Finally, the retrieval of information from a digital interface is another area where AI agents struggle. To gather useful data, these agents often resort to scrolling through digital interface and taking multiple screenshots, which is both inefficient and error-prone. The challenge lies in transforming the raw data shown in a screenshot into a structured, usable format that the AI model can process and analyze. Because of the static nature of screenshots, the agent cannot directly extract or manipulate the data in a meaningful way, making it harder to handle large amounts of information that could be better processed if the digital interface's content (e.g., textual content) were more easily accessible.

It would therefore be advantageous to provide a solution that addresses the above challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

In one general aspect, the method may include receiving, by a first AI agent, a task to be performed on at least one digital interface based on a natural language request from a client device; extracting, by the first AI agent, at least one learned skill to be used by the first AI agent for completing the task based on accessibility semantics of at least one component of the at least one digital interface, where learned skills are capabilities of the first AI agent to interact with the at least one component; completing the task, by the first AI agent, using the at least one learned skill. Other embodiments of this aspect include corresponding computer systems, apparatus, and computer programs recorded on one or more computer storage devices, each configured to perform the actions of the methods.

Implementations may include one or more of the following features. The method may include: saving the at least one learned skill into a cache memory accessible by the first AI agent; analyzing, log data associated with the at least one learned skill used by the first AI agent to complete the task; and saving the log data as the at least one learned skill into the cache memory; completing the task, by the first AI agent, using a series of operations; and extracting, by the first AI agent, the at least one learned skill based on accessibility semantics of the at least one component and the series of operations; identifying, by a second AI agent, the series of operations used by the first AI agent to complete the task; integrating the first AI agent with a set of predefined skills, where predefined skills are capabilities of the AI agent to recognize and interact with the at least one component based on accessibility semantics of the at least one component; determining, by the first AI agent, when at least one predefined skill of the set of predefined skills is applicable to complete the task; when at least one predefined skill is applicable to complete the task, applying the at least one predefined skill to complete the task; and when at least one predefined skill is not applicable to complete the task, applying the at least one learned skill to complete the task; determining, by the first AI agent, when extracting unstructured data into structured format increases the efficiency of the first AI agent to complete the task; and when extracting unstructured data into structured format increases the efficiency of the first AI agent to complete the task, extracting unstructured data into structured format; detecting, by a detection system, accessibility issues of the at least one component; and when an accessibility issue is detected, modifying, by the detection system, the accessibility semantics of the at least one component to make the at least one component machine-readable and machine-operable to a first AI agent.

The method where accessibility issues refer to when accessibility semantics of the at least one component are not machine-readable by accessibility technologies or when the at least one component does not respond predictably to various interactions.

The method where extracting the at least one learned skill is further based on outputs of at least one AI system configured to analyze the at least one digital interface.

The method where modifying, by the detection system, the accessibility semantics of the at least one component further may include: modifying, by the detection system, at least one of: roles of the at least one component, states of the at least one component, values of the at least one component, relationships of the at least one component to at least one other component.

The method where accessibility semantics of the at least one component includes at least one of: roles of the at least one component, states of the at least one component, values of the at least one component, relationships of the at least one component to at least one other component. Implementations of the described techniques may include hardware, a method or process, or a computer tangible medium.

In one general aspect, non-transitory computer-readable medium may include one or more instructions that, when executed by one or more processing circuitries of a device, cause the device to: receive, by a first AI agent, a task to be performed on at least one digital interface based on a natural language request from a client device; extract, by the first AI agent, at least one learned skill to be used by the first AI agent for completing the task based on accessibility semantics of at least one component of the at least one digital interface, where learned skills are capabilities of the first AI agent to interact with the at least one component; and complete the task, by the first AI agent, using the at least one learned skill. Other embodiments of this aspect include corresponding computer systems, apparatus, and computer programs recorded on one or more computer storage devices, each configured to perform the actions of the methods.

In one general aspect, the system may include a processing circuitry. System may also include a memory, the memory containing instructions that, when executed by the processing circuitry, configure the system to: receive, by a first AI agent, a task to be performed on at least one digital interface based on a natural language request from a client device; extract, by the first AI agent, at least one learned skill to be used by the first AI agent for completing the task based on accessibility semantics of at least one component of the at least one digital interface, where learned skills are capabilities of the first AI agent to interact with the at least one component; complete the task, by the first AI agent, using the at least one learned skill. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: save the at least one learned skill into a cache memory accessible by the first AI agent.

The system where the memory contains further instructions which when executed by the processing circuitry further configure the system to: analyze, log data associated with the at least one learned skill used by the first AI agent to complete the task; and save the log data as the at least one learned skill into the cache memory.

The system where the memory contains further instructions which when executed by the processing circuitry further configure the system to: complete the task, by the first AI agent, using a series of operations; and extract, by the first AI agent, the at least one learned skill based on accessibility semantics of the at least one component and the series of operations.

The system where the memory contains further instructions which when executed by the processing circuitry further configure the system to: identify, by a second AI agent, the series of operations used by the first AI agent to complete the task.

The system where the memory contains further instructions which when executed by the processing circuitry further configure the system to: integrate the first AI agent with a set of predefined skills, where predefined skills are capabilities of the AI agent to recognize and interact with the at least one component based on accessibility semantics of the at least one component; determine, by the first AI agent, when at least one predefined skill of the set of predefined skills is applicable to complete the task; when at least one predefined skill is applicable to complete the task, apply the at least one predefined skill to complete the task; and when at least one predefined skill is not applicable to complete the task, apply the at least one learned skill to complete the task.

The system where the memory contains further instructions which when executed by the processing circuitry further configure the system to: determine, by the first AI agent, when extracting unstructured data into structured format increases the efficiency of the first AI agent to complete the task; and when extract unstructured data into structured format increases the efficiency of the first AI agent to complete the task, extracting unstructured data into structured format.

The system where the memory contains further instructions which when executed by the processing circuitry further configure the system to: detect, by a detection system, accessibility issues of the at least one component; and when an accessibility issue is detected, modify, by the detection system, the accessibility semantics of the at least one component to make the at least one component machine-readable and machine-operable to a first AI agent.

The system where accessibility issues refer to when accessibility semantics of the at least one component are not machine-readable by accessibility technologies or when the at least one component does not respond predictably to various interactions.

The system where extracting the at least one learned skill is further based on outputs of at least one AI system configured to analyze the at least one digital interface.

The system where the memory contains further instructions that, when executed by the processing circuitry for modifying, by the detection system, the accessibility semantics of the at least one component, further configure the system to: modify, by the detection system, at least one of: roles of the at least one component, states of the at least one component, values of the at least one component, relationships of the at least one component to at least one other component.

The system where accessibility semantics of the at least one component includes at least one of: roles of the at least one component, states of the at least one component, values of the at least one component, relationships of the at least one component to at least one other component. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 shows an example functional diagram that illustrates accelerating operations of an LLM-based agent according to an embodiment.

FIG. 3 illustrates an example flowchart of a process for enriching an agent's capabilities with knowledge of accessibility semantics of digital interfaces.

FIG. 4 is an example schematic diagram of accelerator system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for accelerating LLM-based agents that perform tasks on digital interfaces. Digital interfaces may include websites or mobile applications, but is not limited to those examples. Accelerating LLM-based agents includes, but is not limited to, accelerating the speed with which an LLM-based agent operates on a digital interface to achieve a task for a user, reducing the computational cost and monetary expense associated with agentic operations (e.g., by reducing the number of calls to LLMs and minimizing repeated screenshot analysis), a combination thereof, and the like. The disclosed embodiments enhance the capabilities of LLM-based agents to interact with and operate on digital interfaces. LLM-based agents'capabilities are enhanced through the provision of pre-defined skills that are based on an ability to identify components on a digital interface and interact with those components. Pre-defined skills include an ability of the agent to recognize components based on their accessibility attributes (hereinafter, accessibility attributes, accessibility semantics, semantic descriptions, or the like) and to efficiently interact with the components based on their accessibility attributes. The use of pre-defined skills by an LLM-based agent requires less processing by the LLM and fewer calls to the LLM to interact with components on a digital interface.

Additionally, the disclosed embodiments provide for an LLM-agent's ability to learn, extract, and cache new skills (hereinafter, new skills or learned skills) based on accessibility attributes in digital interfaces. After an LLM-based agent performs specific tasks on a specific digital interface, the disclosed embodiments allow the LLM-based agent to extract a generalized set of operations, as a learned skill, based on actions used by the LLM-based agent to perform the specific task. Extracting the generalized set of operations is based on accessibility attributes of the digital interface. In some embodiments, skill extraction may occur upon initial loading or first encounter of a digital interface, prior to executing a user-requested task. In such embodiments, the agent analyzes the digital interface using accessibility semantics, and, in some embodiments, computer vision techniques and AI-based analysis, to identify functional groupings of components, such as forms, menus, dialogs, workflows, and the like. Based on this analysis, the agent may extract one or more skills representing semantically defined operations, such as completing a form or navigating a workflow, without having executed those operations previously. In some embodiments, the learned skills that are extracted are associated with stable semantic identifiers and stored in various storage mediums in various configurations to enable retrieval of the extracted learned skills across subsequent encounters with the digital interface. In some embodiments, multiple skills may be chained to perform a more complex task. In some embodiments, learned skills may be augmented with additional steps based on events encountered during execution of a task such as, but not limited to, partial failures, new task configurations, a combination thereof, and the like. For example, an existing learned skill may be augmented with additional steps when a task requires interacting with components not previously encountered. In some embodiments, a complementary skill may be cached for later chaining with an existing skill. Various storage mediums include, but are not limited to, a cache system. The cache system may be a global cache system implemented in, for example, but not limited to, a central caching architecture or a distributed caching architecture. Various caching systems may utilize mechanisms including, but not limited to, in-memory caches, distributed caches, disk-based caches, and hybrid caches. In some embodiments, the learned skills that are extracted may be stored in, for example, but not limited to, a local page associated with a digital interface (e.g., a llm.txt file) and a Model Context Protocol (MCP) server. The caching of learned skills for retrieval by the agent serves to significantly reduce the processing required by the LLM and the amount of calls needed to be made to the LLM to achieve a task.

The disclosed embodiments also provide a detection engine that identifies accessibility compliance violations in digital interfaces. The disclosed detection engine is configured to provide recommendations to improve the accessibility of digital interfaces, including the implementation (e.g. modification) of accessibility attributes (e.g., roles, labels, states, values, and relationships). When accessibility attributes are implemented in digital interfaces, LLM-based agents, equipped with pre-defined skills and learned skills, are able to execute their skills on the digital interfaces based on the implemented accessibility attributes recognized by the detection engine. In some embodiments, improving accessibility semantics via the detection engine not only enables LLM-based agents equipped with predefined or learned skills to operate more efficiently, but also increases the likelihood that agents lacking such skills can successfully complete tasks by making component behavior more predictable and machine-operable. In some embodiments, recommendations include at least one recommendation sent to a user from the detection engine. According to this embodiment, the detection engine is responsive to user input on such recommendations, and the user inputs to the detection engine may be stored in the cache. In some embodiments, the agent may provide the recommendations, send the recommendations, respond to user input on such recommendations, perform a combination thereof, and the like. In some embodiments, the detection engine may automatically implement the recommended improvements to the digital interfaces. In other embodiments, such improvements may be automatically implemented by an LLM-based agent. In some embodiments, improvements to the accessibility semantics may be performed with the assistance of a human developer. In other embodiments, improvements to the accessibility semantics may be performed via an integrated development environment (IDE) providing access to accessibility compliance violations (e.g., a report of such violations). Such access may be provided via Model Context Protocol (MCP), other tool interface, a combination thereof, and the like.

The structure of a digital interface includes components, including both simple components and composite components (such as menus, tablists, accordions, and other multi-element widgets). A component is an element that users engage with to perform an action or view information. A role of a component defines how the component functions, and in combination with an associated label, defines the purpose of the component that the component serves. A state of a component is a current mode of the component such as, but not limited to, “expanded” or “collapsed.” A value of a component is a current input or selection that the component holds such as, but not limited to, “checked” or “unchecked.” Relationships between components determine how the components or elements of the components interact with each other and the overall digital interface. For example, in a parent-child relationship, a listbox is the parent and the list of options are the children. Roles of a component, states of a component, values of a component, and relationships between components or elements of the components are machine readable when the roles, states, values, and relationships are accessible to accessibility technologies (e.g., screen reader). Components are machine operable when the components or elements of the components respond predictably to various interactions with the components or elements.

Components (and components'roles) may include, but are not limited to, a button (to trigger an action or event within the interface), a toggle (to switch between two states or options), a radio button (to select one option from a group of mutually exclusive choices), a text field (to input data, like typing text or entering values), a heading (to define the title or category of a section), a combobox (to choose from a list of options), a checkbox (to select one or more options from a list), a slider (to adjust a value within a defined range), a progress bar (to indicate the completion status of a process or task), a modal window (to present additional content or actions in a temporary overlay), and a tooltip (to offer brief, contextual information about an element when users hover or focus on the element).

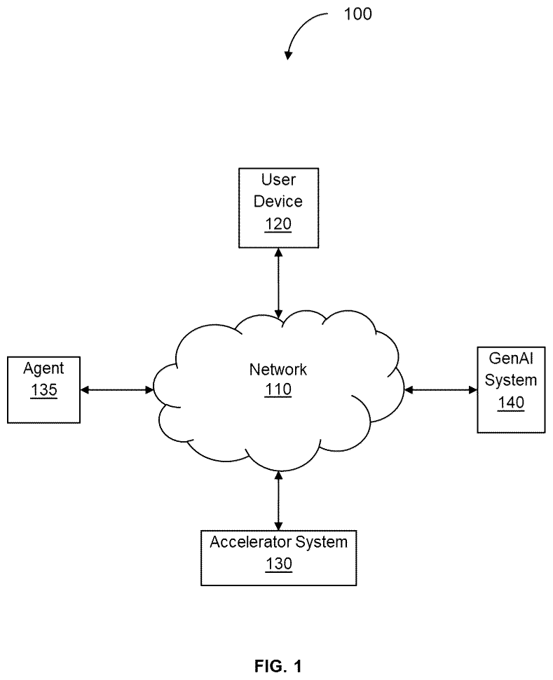

FIG. 1 shows an example network diagram 100 utilized to describe the various disclosed embodiments. In the example network diagram 100, user device 120, an agent 135, generative artificial intelligence (genAI) system 140, and accelerator system 130 communicate via a network 110. The network 110 may be, but is not limited to, a wireless, cellular or wired network, a local area network (LAN), a wide area network (WAN), a metro area network (MAN), the Internet, the world wide web (WWW), similar networks, and any combination thereof.

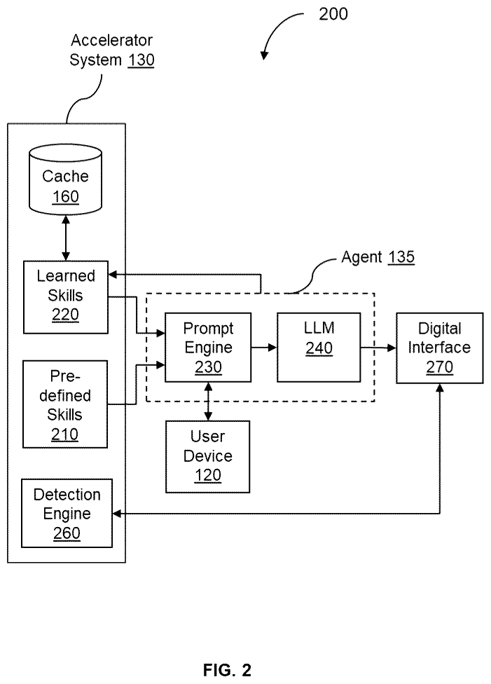

The agent 135 may be a Large Language Model (LLM)-based agent. An LLM-based agent is an AI system built on transformer architectures, such as the Generative Pre-trained Transformer (GPT) model, which rely on self-attention mechanisms to handle sequences of text. In some configurations, the agent 135 includes an orchestration layer, an LLM, and services designed for interacting with digital interfaces. The orchestration layer coordinates the flow of information and task execution between the LLM and the services available to the agent 135. The services are the functional components that the agent 135 uses to interact with digital interfaces, retrieve data, or perform specific tasks. The services may include, but are not limited to, web scraping, interacting with a file system, invoking APIs, controlling a graphical user interface (GUI), making network requests, or executing database queries. Services are what enable the agent 135 to perform specific actions that require more than just text generation. The agent 135 and the elements of the agent 135 are discussed in more detail with respect to FIG. 2.

The LLM may exist as a separate genAI system 140. GenAI system 140, using an LLM, produces new outputs that resemble the structure or characteristics of the training data of the LLM. In an embodiment, the agent 135 may be part of the genAI system 140.

The user device 120 is configured to send user requests as prompts to the agent 135 and to follow-up to responses from the agent 135. A user device 120 may be, but is not limited to, a personal computer, a laptop, a tablet computer, a smartphone, a wearable computing device, or any other device capable of receiving and displaying notifications.

It should be understood that the embodiments described herein are merely exemplary and not intended to be limiting. The arrangement illustrated in FIG. 1 is provided for illustrative purposes only and does not restrict the scope of the disclosed embodiments. Various modifications, adaptations, and alternative configurations may be implemented without departing from the spirit and scope of the disclosed embodiments.

FIG. 2 shows an example functional diagram 200 that illustrates accelerating operations of an LLM-based agent according to an embodiment.

Agent 135 can be realized in software, hardware, firmware, or a combination thereof. The software system comprises one or more computer-readable storage media storing instructions that, when executed by one or more processors, cause the system to perform one or more functions as described herein. The software may be implemented in various programming languages and may operate on different computing environments, including but not limited to cloud-based systems, distributed networks, standalone computing devices, or embedded systems. The software may include algorithms, machine learning models, or rule-based processing to achieve the described functionality. Various implementations may employ modular, service-oriented, or microservice architectures, and the system may interface with databases, APIs, or external services.

The example functional diagram 200 illustrates various disclosed embodiments that allow agent 135 to perform various tasks on a digital interface in response to user requests to achieve those tasks.

Agent 135 includes a prompt engine 230 and one or more LLMs 240. The prompt engine 230 includes an orchestration layer that includes various prompt engineering frameworks (e.g., ReAct, Chain-of-Thought), memory, and instructions. Prompt engine 230 generates a prompt based on the information in its orchestration layer and feeds the prompt to LLM 240.

The LLM 240, when fed the prompt by prompt engine 230, determines the next actions to take. Such actions may access, run, or trigger function calls, data stores, and plugins used to access application programming interfaces (APIs), and the like. The agent 135 may interact with digital interface 270 based on pre-defined skills 210 or learned skills 220.

In an embodiment, when agent 135 does not have any pre-defined skills 210 or learned skills 220 that equip agent 135 to perform operations on the digital interface 270, the agent 135 will perform the operations using traditional agentic techniques of LLM-based agents. Based on the execution of the traditional agentic techniques, learned skills 220, based on a generalized series of operations that the agent used to achieve certain tasks, are extracted. Agent 135 may store learned skills 220 in cache 160 that agent 135 may retrieve in the future to perform similar tasks without extra steps (e.g., calls to the LLM) as may have been required during initial execution of traditional agentic techniques.

In some embodiments, agent 135 is configured to receive a prompt or task description from a user, such as a natural-language instruction (e.g., “order a flight from City X to City Y”). In response, agent 135 is configured to perform an analysis of a web interface through which the task may be completed (e.g., a commercial airline website) to determine which components are relevant to the requested task. The analysis may involve identifying semantic descriptors of components such as, but not limited to, input fields, dropdown menus, buttons, and dialog popups, by inspecting the accessibility attributes of the components.

Using the identified semantic descriptors, agent 135 is configured to determine appropriate interactions with each component to carry out the task. For example, agent 135 may identify a text input field having a role of “combobox” and a label “From,” and may determine that this component is intended to receive an origin airport code or city name. The agent 135 may then semantically associate another field labeled “To” as the destination input field.

When the agent 135 performs the interactions necessary to complete the task, agent 135 is configured to log each step as a semantic action that reflects the intended functional operation as opposed to a series of low-level interface operations (e.g., cursor movements and clicks). For instance, rather than recording the interaction as a sequence of “input text,” “click option X,” and “input text,” the agent 135 is configured to record the operation as “set dropdown value (From=X)” and “set dropdown value (To=Y).”

In certain embodiments, agent 135 is configured to generalize the learned sequence of operations based on the semantic descriptors of the components involved. Because the semantic descriptors provide stable identifiers and roles independent of the visual layout of the web page, the generalized sequence is configured to be applied by the agent 135 to similar subsequent tasks. For example, a learned skill to “order a flight from X to Y” may be reused for “order a flight from W to Z,” even though the selectable options or dropdown contents differ.

In some embodiments, the representation of the sequence of operations generalized by the agent 135 captures the functional meaning of each component involved in the sequence of operations. As a result, the learned skill can be generalized to future tasks with similar goals, even when the layout, position, presentation, or the like of the web page changes.

In some embodiments, agent 135 is configured to record each sequence of interactions as a learned skill along with metadata such as a skill name, description, and logical parameters. The skill description provides a natural-language explanation of the overall procedure, while the logical parameters specify variable elements that can change between executions. When executing a learned skill, agent 135 is configured to substitute new parameter values into the logical parameters of the learned skill while maintaining the same semantically defined sequence of actions. Because agent 135 is configured to use accessibility semantics of components rather than static selectors, agent 135 is configured to robustly identify the intended components even if the web page has been updated or restructured.

During execution of a learned skill, agent 135 is configured to determine which actions are deterministic (e.g., entering text into a labeled field) and which actions involve dynamic inference (e.g., selecting a particular option from a context-dependent dropdown list). In the case that actions involve dynamic inference, agent 135 is configured to invoke LLM 240 to interpret current context and select the appropriate value consistent with the prior learned skill.

In some embodiments, cache 160 may be realized in various storage mediums in various configurations to enable retrieval of the extracted learned skills 220. Various storage mediums include, but are not limited to, a cache system. The cache 160 may be a global cache system implemented in, for example, but not limited to, a central caching architecture or a distributed caching architecture. The cache 160 may utilize mechanisms including, but not limited to, in-memory caches, distributed caches, disk-based caches, and hybrid caches. In some embodiments, the learned skills 220 that are extracted are stored in, for example, but not limited to, a local page associated with a digital interface (e.g., a llm.txt file).

Prompt engine 230 includes a prompt engineering framework such as, but not limited to, the ReAct framework. The various disclosed embodiments provide improvements to such prompt engineering frameworks by equipping the agent 135 with pre-defined skills 210 and an ability to extract, store, and use learned skills 220. Pre-defined skills 210 and learned skills 220 are related to agent 135's ability to operate on digital interfaces, according to the user request, more efficiently by understanding accessibility semantics of various components of digital interfaces. As explained above, components include, but are not limited to, a button, a toggle, a radio button, a text field, a heading, a combobox, a checkbox, a slider, a progress bar, a modal window, and a tooltip. Pre-defined skills 210 include knowledge of the accessibility semantics (such as role, state, value, and relationships) of each component and instructions on how to interact with each component. In an embodiment, pre-defined skills 210 may be integrated into the orchestration layer of agent 135.

As an illustrative example, agent 135 may receive a user request, “I want to book a flight from Austin to Zurich.” The prompt engineering framework of prompt engine 230 includes a logical sequence to take action on the user request, “I want to book a flight from Austin to Zurich.” Prompt engine 230 cyclically prompts LLM 240 to generate each of the steps in the logical sequence, which may include, but is not limited to, a question, thought, action, action input, observation, and final answer, as illustrated in the following paragraphs.

The question includes the user request. Prompt engine 230 prompts LLM 240 with the question, “I want to book a flight from Austin to Zurich,” and LLM 240 outputs the thought. The thought is LLM 240's thought(s) about what it should do next. LLM 240 may output the thought, “I should search for flights,” to prompt engine 230.

Prompt engine 230 prompts LLM 240 with the thought “I should search for flights,” and LLM 240 outputs an action. The action is LLM 240's decision on what action to take next. Prompt engine 230 prompts LLM 240 to determine the next action in the flow of the agent.

Prompt engine 230 prompts LLM 240 with the action and action input, and LLM 240 outputs an observation. The observation is the result of the action and action input sequences. The sequence (loop) of thought, action, action input, and observation may be repeated N-times, wherein N is an integer greater than 1. The various disclosed embodiments, as explained herein, allow for this loop to be repeated far fewer times than allowed by traditional agentic techniques. The observation determined by LLM 240 may be “return many options for flights from Austin to Zurich.” The observation is sent to prompt engine 230.

Prompt engine 230 prompts LLM 240 with the observation, and LLM 240 outputs a final answer. The final answer is the final response to the original user request. This final answer is sent from LLM 240 to the user.

According to various disclosed embodiments, prompt engine 230 operates on a prompt engineering framework that is informed by pre-defined skills 210 and learned skills 220. The logical framework underlying prompt engine 230 operates more efficiently by including pre-defined skills 210 and learned skills 220 related to the accessibility semantics of digital interfaces. Providing such skills to prompt engine 230 allows agent 135 to operate over fewer cycles, for example, of the thought, action, action input, and observation loop. Agent 135 determines thoughts, actions, and action inputs based on pre-defined skills 210 of accessibility semantics and the ability of agent 135 to learn new skills (learned skills 220) related to accessibility semantics. This allows agent 135 to deliver a final answer to the user in response to the user request more efficiently without having to call the LLM at every step in the sequence.

For example, as in the previous example, agent 135 may encounter a long list of departure and arrival flights to and from Austin and Zurich on the flight booking system on a digital interface. Without being equipped with pre-defined skills 210 and learned skills 220, agent 135 would scroll through all of the observed flights data and take successive screen shots at various increments and segmentally feed the observations back to the LLM 240. The inefficiency associated with this segmental approach is eliminated through the disclosed embodiments providing pre-defined skills 210 and learned skills 220 based on accessibility semantics. For example, achievement of the task is accelerated by instructing the agent 135 with the ability to find the relevant components (e.g., “Departure” and “Arrival” fields) and to interact with the components.

In an embodiment, agent 135 may be equipped with the ability to extract the unstructured flights data on the flights booking system digital interface into an appropriate structured format including, but not limited to, a table. Processing the data this way allows agent 135 to more efficiently make observations, allowing fewer cycles through the orchestration layer included in prompt engine 230.

Additionally, detection engine 260 may detect accessibility issues on the digital interface 270 accessed by the agent 135. Detecting accessibility issues on digital interfaces allows for recommendations to improve the accessibility semantics of the components of the digital interfaces. Improvements in the accessibility semantics of the components of digital interfaces involves making roles, states, values, and relationships to be machine readable and machine operable by the agent 135. Making components machine readable and machine operable allows the pre-defined skills 210 and learned skills 220 of the agent 135 to be active based on the accessibility semantics of the components. In an embodiment, detection engine 260 can run a script either in the digital interface 270, or detection engine 260 can run as a component of the operating system (OS) that hosts the digital interface. An example implementation of detection engine 260 can be found in the referenced-above U.S. patent application Ser. No. 18/782,049.

It should be understood that the engines, modules, and components described in reference to FIG. 2 may be implemented in software, firmware, hardware, or any combination thereof. In embodiments where the engines are implemented in software, they may comprise instructions stored on a non-transitory computer-readable medium and executed by one or more processors to perform the described functions. The scope of the disclosed embodiments is not limited to any particular implementation, and various modifications, adaptations, and equivalent arrangements may be made without departing from the disclosed embodiments.

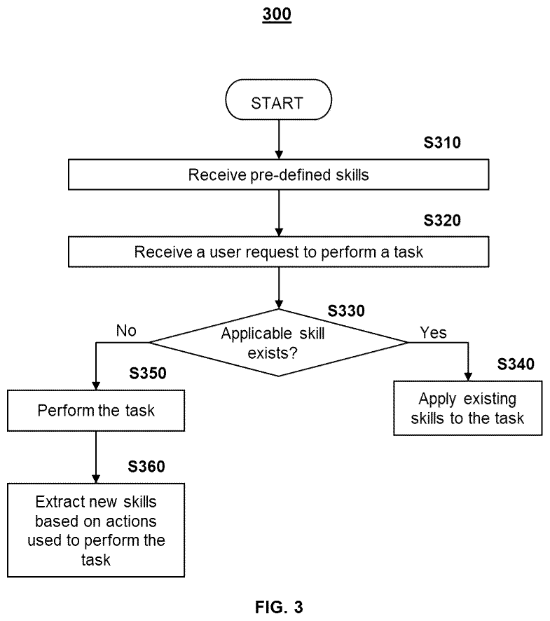

FIG. 3 illustrates an example flowchart 300 of a process for enriching an agent's capabilities with knowledge of accessibility semantics of digital interfaces. In an embodiment, enriching an agent's capabilities as such is performed by accelerator system 130.

The example flowchart 300 illustrates various disclosed embodiments that allow agent 135 to perform actions on digital interfaces based on knowledge of accessibility semantics of various components of the digital interfaces, enabling more efficient interaction of agent 135 on the digital interfaces.

At S310, pre-defined skills are received. Pre-defined skills are capabilities of an agent to interact with components of digital interfaces based on knowledge of the accessibility semantics of the components. Interacting with components based on knowledge of accessibility semantics includes the ability to identify and interact with components. Accessibility semantics includes the roles, states, values, and relationships of each component.

In an embodiment, the pre-defined skills may also include the ability to extract various forms of unstructured data on digital interfaces into structured formats. According to this embodiment, an agent has the ability to determine when extracting and converting unstructured data into structured format increases the efficiency of the agent to accomplish the task. An example of an agent performing this pre-processing of unstructured data is explained hereinabove with respect to FIG. 2.

In an embodiment, the technical benefits, including, but not limited to increased agentic efficiency, of receiving pre-defined skills on accessibility semantics and how to use the accessibility semantics to perform tasks on a digital interface more efficiently are discussed in detail with respect to FIG. 2.

At S320, a user request to perform a task is received. A user request may include a natural language request. In an embodiment, the user request may include a natural language component and a structured language component. In an embodiment, the user request is sent by a user through user device 120, FIG. 1.

Receiving a user request may include receiving a prompt or task description from a user (e.g., “order a flight from City X to City Y”). In response, an analysis is performed of a web interface through which the task may be completed (e.g., a commercial airline website) to determine which components are relevant to the requested task.

At S330, it is determined whether one or more skills applicable to achieving the task exist. If YES, execution proceeds with S340. If NO, execution proceeds with S350.

A skill exists when the skill is a pre-defined skill or learned skill. When the existing skill is not a pre-defined skill, it is a learned skill, and vice versa. A learned skill is defined as a skill that generalizes a series of operations used by an agent to achieve a task. The generalized series of operations are stored in cache memory as a learned skill. Extracting the learned skill from a series of operations and caching the learned skill is discussed in more detail herein.

At S340, the one or more existing skills applicable to achieve the task are applied to achieve the task. The one or more existing skills may be pre-defined skills, learned skills, or a combination thereof. When one of the existing skills are learned skills, the learned skills are retrieved from, for example, cache memory. Various embodiments with respect to caching and retrieving learned skills are discussed hereinabove.

At S350, when there are no existing skills, the actions to achieve the task are performed on the digital interface. In an embodiment, the actions to achieve the task are based on the traditional capabilities of an agent (without pre-defined skills or learned skills), such as, but not limited to, scrolling, clicking, taking screenshots, and typing.

At S360, new skills are extracted based on actions used to perform the task. When the agent with traditional capabilities performs actions to achieve the task on a digital interface, the actions performed are saved as a learned skill. In one embodiment, the actions may be saved by analyzing the log data associated with the actions. In another embodiment, the agent may recognize the actions used to perform the task and save the actions. In another embodiment, a separate, observer agent may be employed to log the series of operations taken by the agent. Additionally, the agent is configured to identify any components on a digital interface that the agent may interact with more efficiently through the identification of the accessibility semantics of components. This configuration allows the agent to save an optimal series of operations based on the components the agent is required to interact with to achieve the task.

In some embodiments, extracting new skills involves identifying semantic descriptors of components such as, but not limited to, input fields, dropdown menus, buttons, and dialog popups, by inspecting the accessibility attributes of the components. In some embodiments, using the identified semantic descriptors, appropriate interactions with each component are determined to carry out the task. For example, a text input field having a role of “combobox” and a label “From,” may be identified, and it may be determined that this component is intended to receive an origin airport code or city name. Additionally, another field labeled “To” may be identified by using semantic descriptors as the destination input field.

In some embodiments, each step taken as part the interactions used to complete the task is logged as a semantic action that reflects the intended functional operation as opposed to a series of low-level interface operations (e.g., cursor movements and clicks). For instance, rather than recording the interaction as a sequence of “input text,” “click option X,” and “input text,” the operation is recorded as “set dropdown value (From=X)” and “set dropdown value (To=Y).”

In certain embodiments, the learned sequence of operations is generalized based on the semantic descriptors of the components involved. Because the semantic descriptors provide stable identifiers and roles independent of visual layout of the web page, the generalized sequence may be applied to similar subsequent tasks. For example, a learned skill to “order a flight from X to Y” may be reused for “order a flight from W to Z,” even though the selectable options or dropdown contents differ.

In some embodiments, the generalized representation of the sequence of operations captures the functional meaning of each component involved in the sequence of operations. As a result, the learned skill can be generalized to future tasks with similar goals, even when the layout, position, presentation, or the like of the web page changes.

In some embodiments, each sequence of interactions is recorded as a learned skill along with metadata such as a skill name, description, and logical parameters. The skill description provides a natural-language explanation of the overall procedure, while the logical parameters specify variable elements that can change between executions. When executing a learned skill, new parameter values are substituted into the logical parameters of the learned skill while maintaining the same semantically defined sequence of actions. Because accessibility semantics of components are used rather than static selectors, the intended components are robustly identified even if the web page has been updated or restructured.

During execution of a learned skill, some actions are determined as deterministic (e.g., entering text into a labeled field) and some actions are determined as involving dynamic inference (e.g., selecting a particular option from a context-dependent dropdown list). In the case that actions involve dynamic inference, a large language model (e.g., LLM 240, FIG. 2) is invoked to interpret current context and select the appropriate value consistent with the prior learned skill.

For example, an agent may, in response to a user request to find flights from Austin to Zurich, save the actions that the agent took to achieve the task. The actions may be to find a “From” flight from Austin, a “To” flight to Zurich, a start date, and an end date on a flight booking system X. These actions used may be saved as a learned skill called “search flights on flight booking system X.” Extracting and saving the actions as a learned skill off-loads from the agent the burden of cycling through logical sequences and LLM calls to achieve the task and instead allows the agent to simply retrieve a saved learned skill generalized to a particular task such as flight booking.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

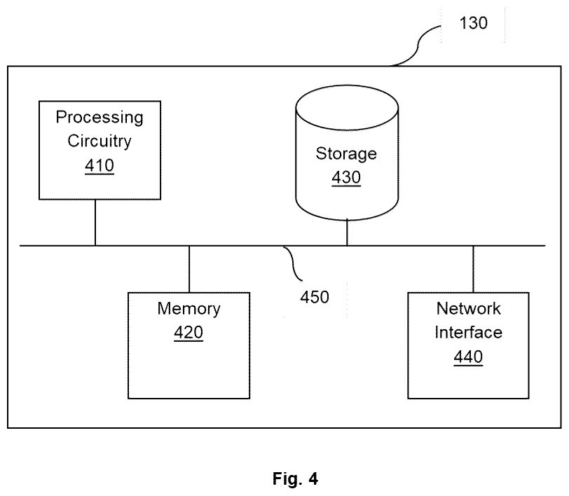

FIG. 4 is an example schematic diagram of accelerator system 130 according to an embodiment. Accelerator system 130 includes a processing circuitry 410 coupled to a memory 420, a storage 430, and a network interface 440. In an embodiment, the components of accelerator system 130 may be communicatively connected via a bus 450.

In various embodiments, the processing circuitry 410 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 410 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 410 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds of activities), networking and connectivity (e.g., in order to support seamless data transfer for deployments involving communications between or among multiple machines or clusters), combinations thereof, and the like.

In embodiments that utilize large language models (LLMs) or otherwise perform operations that may require or be enhanced through the use of parallel processing, the processing circuitry 410 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors during attention weight computation. In at least some such embodiments using GPUs, the processing circuitry 410 may include a number of CPU cores that is equal to or greater than the number of GPUs in order to facilitate or otherwise support parallel processing via multiple GPUs.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows accelerator system 130 to communicate with, for example the user device 120, the agent 135, and/or the genAI system 140.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for accelerating operations of an AI agent, comprising:
receiving, by a first AI agent, a task to be performed on at least one digital interface based on a natural language request from a client device;
extracting, by the first AI agent, at least one learned skill to be used by the first AI agent for completing the task based on accessibility semantics of at least one component of the at least one digital interface, wherein learned skills are capabilities of the first AI agent to interact with the at least one component; and
completing the task, by the first AI agent, using the at least one learned skill.

2. The method of claim 1, further comprising:
saving the at least one learned skill into a cache memory accessible by the first AI agent.

3. The method of claim 1, further comprising:
completing the task, by the first AI agent, using a series of operations; and
extracting, by the first AI agent, the at least one learned skill based on accessibility semantics of the at least one component and the series of operations.

4. The method of claim 2, further comprising:
analyzing, log data associated with the at least one learned skill used by the first AI agent to complete the task; and
saving the log data as the at least one learned skill into the cache memory.

5. The method of claim 3, further comprising:
identifying, by a second AI agent, the series of operations used by the first AI agent to complete the task.

6. The method of claim 1, further comprising:
integrating the first AI agent with a set of predefined skills, wherein predefined skills are capabilities of the AI agent to recognize and interact with the at least one component based on accessibility semantics of the at least one component;
determining, by the first AI agent, when at least one predefined skill of the set of predefined skills is applicable to complete the task;
when at least one predefined skill is applicable to complete the task, applying the at least one predefined skill to complete the task; and
when at least one predefined skill is not applicable to complete the task, applying the at least one learned skill to complete the task.

7. The method of claim 1, further comprising:
determining, by the first AI agent, when extracting unstructured data into structured format increases the efficiency of the first AI agent to complete the task; and
when extracting unstructured data into structured format increases the efficiency of the first AI agent to complete the task, extracting unstructured data into structured format.

8. The method of claim 1, further comprising:
detecting, by a detection system, accessibility issues of the at least one component; and
when an accessibility issue is detected, modifying, by the detection system, the accessibility semantics of the at least one component to make the at least one component machine-readable and machine-operable to a first AI agent.

9. The method of claim 8, wherein accessibility issues refer to when accessibility semantics of the at least one component are not machine-readable by accessibility technologies or when the at least one component does not respond predictably to various interactions.

10. The method of claim 1, wherein extracting the at least one learned skill is further based on outputs of at least one AI system configured to analyze the at least one digital interface.

11. The method of claim 1, wherein modifying, by the detection system, the accessibility semantics of the at least one component further comprises:
modifying, by the detection system, at least one of: roles of the at least one component, states of the at least one component, values of the at least one component, relationships of the at least one component to at least one other component.

12. The method of claim 1, wherein accessibility semantics of the at least one component includes at least one of: roles of the at least one component, states of the at least one component, values of the at least one component, relationships of the at least one component to at least one other component.

13. A non-transitory computer-readable medium storing a set of instructions for accelerating operations of an AI agent, the set of instructions comprising:
one or more instructions that, when executed by one or more processing circuitries of a device, cause the device to:
receive, by a first AI agent, a task to be performed on at least one digital interface based on a natural language request from a client device;
extract, by the first AI agent, at least one learned skill to be used by the first AI agent for completing the task based on accessibility semantics of at least one component of the at least one digital interface, wherein learned skills are capabilities of the first AI agent to interact with the at least one component; and
complete the task, by the first AI agent, using the at least one learned skill.

14. A system for accelerating operations of an AI agent comprising:
a processing circuitry;
a memory, the memory containing instructions that, when executed by the processing circuitry, configure the system to:
receive, by a first AI agent, a task to be performed on at least one digital interface based on a natural language request from a client device;
extract, by the first AI agent, at least one learned skill to be used by the first AI agent for completing the task based on accessibility semantics of at least one component of the at least one digital interface, wherein learned skills are capabilities of the first AI agent to interact with the at least one component; and
complete the task, by the first AI agent, using the at least one learned skill.

15. The system of claim 14, wherein the memory contains further instructions which when executed by the processing circuitry further configure the system to:
save the at least one learned skill into a cache memory accessible by the first AI agent.

16. The system of claim 15, wherein the memory contains further instructions which when executed by the processing circuitry further configure the system to:
analyze, log data associated with the at least one learned skill used by the first AI agent to complete the task; and
save the log data as the at least one learned skill into the cache memory.

17. The system of claim 14, wherein the memory contains further instructions which when executed by the processing circuitry further configure the system to:
complete the task, by the first AI agent, using a series of operations; and
extract, by the first AI agent, the at least one learned skill based on accessibility semantics of the at least one component and the series of operations.

18. The system of claim 17, wherein the memory contains further instructions which when executed by the processing circuitry further configure the system to:
identify, by a second AI agent, the series of operations used by the first AI agent to complete the task.

19. The system of claim 14, wherein the memory contains further instructions which when executed by the processing circuitry further configure the system to:
integrate the first AI agent with a set of predefined skills, wherein predefined skills are capabilities of the AI agent to recognize and interact with the at least one component based on accessibility semantics of the at least one component;
determine, by the first AI agent, when at least one predefined skill of the set of predefined skills is applicable to complete the task;
when at least one predefined skill is applicable to complete the task, apply the at least one predefined skill to complete the task; and
when at least one predefined skill is not applicable to complete the task, apply the at least one learned skill to complete the task.

20. The system of claim 14, wherein the memory contains further instructions which when executed by the processing circuitry further configure the system to:
determine, by the first AI agent, when extracting unstructured data into structured format increases the efficiency of the first AI agent to complete the task; and
when extract unstructured data into structured format increases the efficiency of the first AI agent to complete the task, extracting unstructured data into structured format.

21. The system of claim 14, wherein the memory contains further instructions which when executed by the processing circuitry further configure the system to:
detect, by a detection system, accessibility issues of the at least one component; and
when an accessibility issue is detected, modify, by the detection system, the accessibility semantics of the at least one component to make the at least one component machine-readable and machine-operable to a first AI agent.

22. The system of claim 21, wherein accessibility issues refer to when accessibility semantics of the at least one component are not machine-readable by accessibility technologies or when the at least one component does not respond predictably to various interactions.

23. The system of claim 14, wherein extracting the at least one learned skill is further based on outputs of at least one AI system configured to analyze the at least one digital interface.

24. The system of claim 14, wherein the memory contains further instructions that, when executed by the processing circuitry for modifying, by the detection system, the accessibility semantics of the at least one component, further configure the system to:
modify, by the detection system, at least one of:
roles of the at least one component, states of the at least one component, values of the at least one component, relationships of the at least one component to at least one other component.

25. The system of claim 14, wherein accessibility semantics of the at least one component includes at least one of:
roles of the at least one component, states of the at least one component, values of the at least one component, relationships of the at least one component to at least one other component.
